(19) United States
(12) Patent Application Publication
(10) Pub. No.: US 2005/0038665 A1
(43) Pub. Date: Feb. 17, 2005

(54) Measurement system and measurement method

(76) Inventor: Kunio Hasebe, Tokyo (JP)

Correspondence Address: Paul D Greeley;Ohlandt Greeley Ruggiero & Perle, 10th Floor, One Landmark Square, Stamford, CT, 06901-2682, US

(21) Appl. No.: 10/494,101

(22) PCT Filed: Nov. 1, 2002
(86) PCT No.: PCT/JP02/11439

(30) Foreign Application Priority Data
Nov. 1, 2001 (JP) 2001-336410

(51) Int. Cl. G06F 17/60

(52) U.S. Cl. 705/1

(57) ABSTRACT

A low cost sophisticated measurement system is provided. A measuring instrument to which a device under test is connected, and an associated apparatus which provides application software for converting measurement data are connected through a communications network. The associated apparatus records a usage fee of the application software.

### TECHNICAL FIELD

The present invention generally relates to measurement systems and, more specifically, to a low-cost variable-function-type measurement system that reduces user load.

### Background Art

Currently, at any stage of development, manufacture, operation, maintenance, disposal, and recycling of apparatuses/systems typified by electrical/electronic devices, a measuring instrument and an associated apparatus for performing measurement and control of relevant physical quantities or a measurement system combining them are often required.

A measuring instrument performs generation, conversion, and measurement of a physical quantity related to a device to be tested (a device under test: hereinafter referred to as a “DUT”), performs analysis based on a measurement value, and performs display, storage, and transmission/reception of the measurement value or analysis results.

The associated apparatus includes a data processing device such as a computer and a printer, a peripheral device, a communication device, and so on. The associated apparatus may be pre-included in a measuring instrument or may be provided externally and independently.

Conventionally, in order to meet increasing demands for measurement, a more sophisticated, higher-performance measurement system has been provided by interconnecting a plurality of measuring instruments and associated apparatuses to make use of synergy effects.

Hereinafter, a description will be given in connection with an electrical/electronic measurement system by way of example. The description herein can often be easily extended to, and a related explanation easily given of, for example, those using converters (transducers) for thermoelectric conversion, photoelectric conversion, and so on, those performing mechanical measurement of mechanical quantities, and those using chemical reactions.

A conventional example of such measurement systems will be briefly described with reference to FIG. 7.

In FIG. 7, an associated apparatus 14, such as a computer, exchanges data with one or more measuring instruments 16, 17, 18, etc. through communication means 12, 22, etc. The measuring instrument 16 is connected to a DUT 15 (e.g., amplifier A) to measure a physical quantity (e.g., an input voltage or an output voltage) related to the DUT 15. The measuring instrument 16 transmits the resulting measurement value (e.g., an input voltage V1 or an output voltage V2) as measurement data typically expressed in a digital format, together with accompanying data, to the associated apparatus 14 through the communications-network connection device 22 and the communications network 12.

In FIG. 7, the illustration of DUTs connected to the measuring instruments 17 and 18 has been omitted. The measuring instrument 18 can also be an associated apparatus. The communications network can be one of a wired communications network, a wireless communications network, and an optical communications network.

FIG. 8 shows a typical configuration of the measuring instrument 16. While the configuration of the measuring instrument 16 is well known to those skilled in the art, a brief description thereof is given below. In many cases, the measuring instrument 16 is generally a type of computer-controlled device which is controlled by a microcomputer 34 via an internal bus 24. The measuring instrument 16 has a signal transmission/reception standardizing means 37 which connects to the DUT 15 to transmit/receive a signal to/from the DUT 15. The signal transmission/reception standardizing means 37 is connected to the internal bus 24 and a hardware controlling means 35 for controlling the operation of the signal transmission/reception standardizing means 37, so as to perform communication in a digital data format. A measurement data memory 44 is connected to the hardware controlling means 35 and the internal bus 24. In the measurement data memory 44, measurement data, including transmission data, reception data, hardware setting data, and so on, are stored. An operation panel for performing manual input and instruction inputting means 38 for performing instruction input processing, for example, interpret an input instruction, transfer the input instruction to the bus 24, and turn on an indicator light in response to an instruction from the microcomputer 34. Further, the measuring instrument 16 can include an I/O slot 43 for connection with another apparatus and/or an extended memory. Additionally, the measuring instrument 16 can include an application memory 42 for storing application software for converting measurement data, thereby allowing for various types of analysis. The analysis result and measurement data are stored in a display memory 41 and is displayed on a display device 33. Further, communication (port) means 32 for external communication is provided and is connected to the external communications network 12 via the communications connection 22. While the communication (port) means 32 may be realized by inserting a card into the I/O slot 4, it is independently illustrated for clarity of the description herein.

Typical examples of such a measurement system include an IEC-standard GPIB (General Purpose Interface Bus) measurement system. In the system, a large number of measuring instruments are connected to a bus, so that a master measuring instrument or associated apparatus can use other measuring instruments as slaves to control the overall data flow and timing.

In another type, a large number of cards provided with single-function data converters, signal generators, or measuring instruments having relatively-simple measurement functions are housed in cages, and they are controlled together by a dedicated control device or a general-purpose control device (a computer), thereby performing a series of measurements.

Additionally, a measurement system for performing enterprise-wide or world-wide measurement/control over the Internet has been implemented by, for example, a measurement system incorporating the test/measurement programming software LabVIEW™ available from Japan National Instruments Corporation.

Similarly, for a measuring instrument, one that operates as an http server on the Internet has been developed, including TDS3003B of Tektronix Inc. Image transfer, external control, and application reference are also possible. Further, software can be downloaded by specifying an IP address.

In the field of measurement centering on electronic measurement, however, it is desired that various types of measurements, a variety of data analyses, and a variety of displays can be achieved without the loss of immediacy. Regardless of the presence or absence of a converter (transducer), there is a demand for a great variety of measurements and analyses and/or display of the results. Examples thereof include the measurement of scalar quantities or vector quantities of voltage, current, or power; the analysis of statistics, such as the average or correlation of measurement results or spectral analysis using orthogonal functions; or specific analysis with attention being paid to a specific parameter; and display using tables, graphs, or animations.

The ways such measurement, analysis, and display are conducted considerably changing in short periods of time in conjunction with changes in measurement quantities, changes in analysis methods, or optimizations in display.

Additionally, in measurement systems using an application having large-scale software, in recent years, it has become difficult to configure everything with system components (including both hardware and software) owned by a single company or party. Buying system components only for a short period of use is costly, and software used for downloading or the like also involves a reduction in measurement speed of measuring instruments, the provision of download space, and work for downloading, and so on. Furthermore, usage-fee payment is procedurally cumbersome.

### DISCLOSURE OF THE INVENTION

An object of the present invention is to provide a low-cost, sophisticated measurement system that can eliminate or alleviate some of the problems described above.

To achieve the object of the present invention, in principle, a measurement system and a measurement method of the present invention reduce the number of hardware parts unique to a measuring instrument and use expensive application software only when necessary.

A first aspect of the present invention provides a measurement system. The measurement system includes instruction inputting means having an operation panel for inputting an instruction regarding a configuration of the measurement system, a test interface, signal transmission/reception standardizing means for transmitting/receiving a signal to/from a device under test via the test interface, and transmitting means for transmitting information to a communications network. The information is based on at least part of a measuring function and an output from the signal transmission/reception standardizing means. The measurement system further includes application executing means. Upon connection with the communications network to receive the information, the application executing means either performs conversion specified by the information on the information to obtain measurement information and transmitting the measurement information to the communications network or transmits application software for performing the conversion. The measurement system further includes receiving means for receiving the measurement information from the communications network, displaying means for performing display in accordance with the application software or the measurement information received by the receiving means, and billing means for updating a given billing record in response to the conversion or the transmission of the application software.

The application executing means may have a billing means and transmit at least part of the billing record based on the measurement information together with the measurement information. Even when expensive application software is used, the arrangement facilitates the management of measurement costs, thereby allowing for its use with a sense of security. It is readily understood that the billing means may be provided separately from the application executing means.

Additionally, the application executing means may have an electronic mall function that allows a large number of sets of the conversions to be displayed and that allows a desired one of the conversions or the application software to be selected and specified through setting of the operation panel. This arrangement ensures an estimate of costs (usage charges) and performance and allows for the use of application software at a high cost/performance ratio. When the operation panel, the transmitting means, and the receiving means are included in a portable information terminal or a mobile phone, a section unique to a measuring instrument is reduced in size, thereby providing the advantage of reducing measurement costs. Further, when the portable information terminal or the mobile phone includes the displaying means, that advantage is further enhanced.

When the operation panel, the transmitting means, the receiving means, and the displaying means are included in a personal computer, it is convenient since sophisticated functions of the personal computer can be used.

A second aspect of the present invention provides a measurement system in which a measuring instrument to which a device under test is connected, and an associated apparatus which provides application software for converting measurement data are connected through a communications network. The associated apparatus records usage fees for the application software. This provides an advantage in that the application software in the measuring system can be sold in an appropriate manner.

The measuring instrument can download the application software from the associated apparatus and can execute the application software to record amounts of use for calculation of usage fees, and the associated apparatus can receive the amounts of use and can calculate the usage fees. This arrangement makes it possible to count the number of uses of the application software and to thereby charge a fee corresponding to the number of uses.

The measuring instrument can download the application software from the associated apparatus, receive a limit value for an amount of use, and execute the application software within the limit value. This arrangement can prevent excessive use from occurring, which is advantageous for not only the user of the measuring instrument but also the provider of the application software.

The measuring instrument can further record the amount of use of the application software and transmit a difference between the amount of use and the limit value to the associated apparatus. This makes it possible to adjust the fee corresponding to an unused part even in an operation using a method for charging based on a limit value, thereby allowing for more rational measurement at lower cost.

A third aspect of the present invention provides a method for performing measurement in a measurement system in which a measuring instrument is connected to an associated apparatus through a communications network. The measuring instrument includes a measuring section to which a device under test is connected and a master device for controlling the measuring section to thereby perform measurement of the device under test. The method includes a step of preparing a device under test (DUT), a step of connecting the DUT and a measuring section to a master device 562, and a step of putting the DUT, the measuring section, and the master device into a state in which measurement can be started. The method further includes a step of connecting the master device and the associated apparatus to put the master device and the associated apparatus into a state in which communication can be performed, a step of causing the master device to place an order for downloading desired application software with the associated apparatus according to a certain usage condition, the desired application software being selected in accordance with an instruction from an operation panel of the master device. The method further includes a step of causing the associated apparatus to approve a validity of the order, download the desired application software onto the master device, and store the start of use. The method further includes a step of causing the master device to store the desired application software and execute measurement of the DUT, a step of causing the master device to erase the desired application software in response to the ending of the measurement that uses the desired application software and simultaneously transmit an erase notification to the associated apparatus, and a step of causing the associated apparatus to calculate a usage fee upon receipt of the erase notification and record the usage fee.

The adoption of such a measurement method allows appropriate use of a variety of application software at low cost.

In the step of storing the start of use, the start time of the download can be stored, and in the step of calculating and recording the usage fee, based on an elapsed time from the start time until the erase notification is received, a usage fee corresponding to the elapsed time can be calculated and recorded.

This allows for charging a fee corresponding to the usage time of the application software and for avoiding the unauthorized storage of the application software on the measuring instrument side.

In addition, in the step of storing the start of use, the associated apparatus can transfer a counter module for counting the number of uses of the desired application software to the master device together with the download mentioned above, and in the step of executing the measurement, the counter module can count the number of uses. Further, in the step of transmitting the erase notification, the counter module can be collected, and in the step of calculating and recording the usage fee, a usage fee can be calculated by reading the number of uses from the counter module.

This allows for charging a fee corresponding to the number of uses of application software and for avoiding the unauthorized storage of the application software in the measuring instrument.

In the step of executing the measurement, the associated apparatus can transmit the elapsed time or the usage fee to the master device.

This allows a fee during measurement to be sequentially recognized, thus making it possible to eliminate unwanted cost and to facilitate an improvement in the cost-to-effect ratio of the measurement.

Additionally, when the master device displays the transmitted elapsed time or the usage fee, cost consciousness can be further enhanced.

### BRIEF DESCRIPTION OF THE DRAWINGS

FIG. 1 is a schematic block diagram of a measurement system according to the present invention.

FIG. 2 is a block diagram of a first embodiment of an associated apparatus for use in the measurement system shown in FIG. 1.

FIG. 3 is a block diagram of a first embodiment of a measuring instrument for use in the measurement system shown in FIG. 1.

FIG. 4 is a block diagram of a second embodiment of the measuring instrument for use in the measurement system shown in FIG. 1.

FIG. 5 is a block diagram of a third embodiment of the measuring instrument for use in the measurement system shown in FIG. 1.

FIG. 6 is a flow diagram for illustrating a measurement method for the measurement system of the present invention, the measurement system employing the measuring instrument shown in FIG. 5.

FIG. 7 is a block diagram of a measurement system for illustrating a related art.

FIG. 8 is a block diagram of a measuring instrument for use in the measurement system shown in FIG. 1.

### BEST MODE FOR CARRYING OUT THE INVENTION

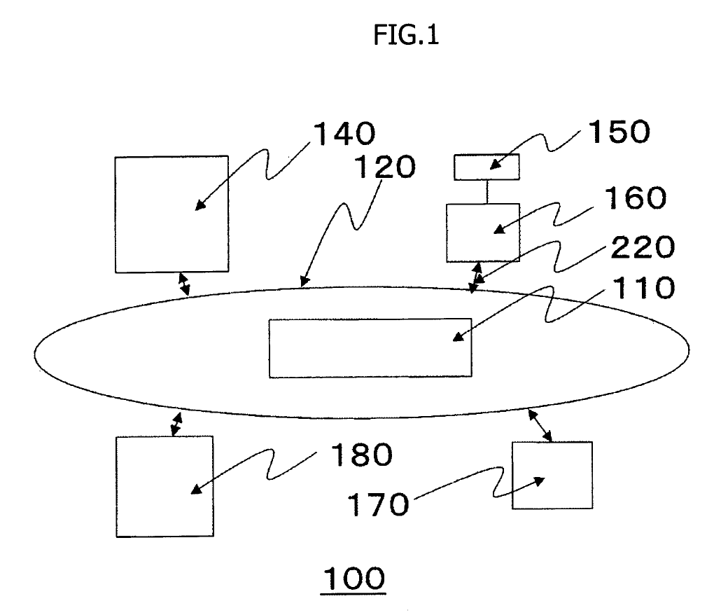

FIG. 1 schematically shows a measurement system 100 for describing the general form of an embodiment of the present invention.

In FIG. 1, an associated apparatus (e.g., a computer or server) 140, such as a computer, and one or more measuring instruments 160, 170, 180, etc. are configured through means 120, 220, etc. for communication over a communications network to allow for desired measurement. It is assumed that the owners, right holders, and parties concerned with use/operation of those apparatuses and devices have reached an agreement in advance about required rights/obligations (usage conditions, connection conditions, authentication methods, and so on) by using a conventionally-known method. The measuring instrument 160 is connected to a device under test (DUT) 150 (e.g., an amplifier A or a generator of a voltage V). The measuring instrument 160 measures a physical quantity (e.g., an input voltage or an output voltage) related to the DUT 150. The measuring instrument 160 transmits the resulting measurement value (e.g., an input voltage V1 or an output voltage V2) as measurement data typically expressed in a digital format, together with accompanying data, to the associated apparatus 140 through the communications-network connection device 220 and the communications network 120. Network management/operation means 110, which is provided as needed, constructs, operates, and maintains the communications network for the communication means 220. The network management/operation means 110 is provided by, for example, a type-1 telecommunications carrier, such as NTT. When an independent LAN or a wireless communications network is used as the communication means 220, there is no need to provide the network management/operation means 110 for understanding the present invention.

In FIG. 1, the illustration of DUTs that are connected to the measuring instruments 170 and 180 has been omitted. The measuring instruments 170 and 180 can also be associated apparatuses. The communications network may be any of a wired communications network, a wireless communications network, an optical communications network, and so on.

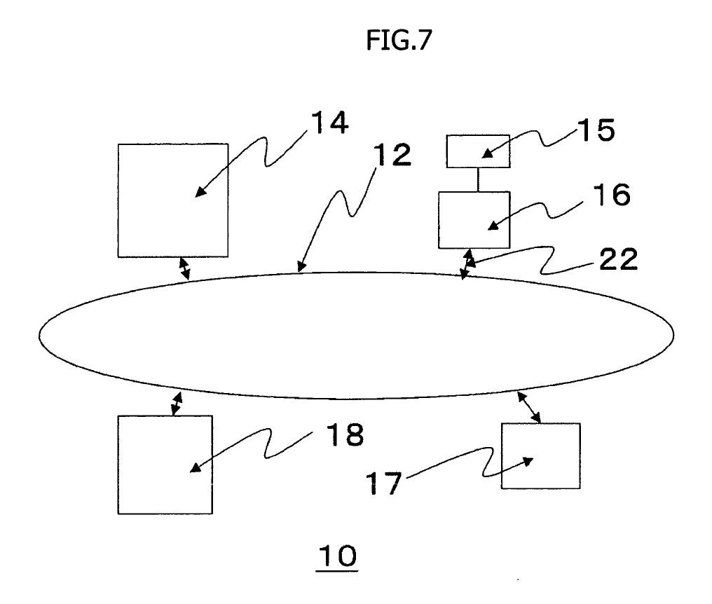

The configuration described above, except for the network management/operation means 110, appears to be analogous to the configuration of the conventional example shown in FIG. 7. It will be understood, however, that the details and the advantages of the configurations greatly differ from each other, as described in detail below.

While the following description is mainly directed to the associated apparatus 140, the measuring instrument 160, and modifications and applications thereof, pluralities of other associated apparatuses and measuring instruments may be provided and the functional performances thereof may also differ. The description, however, is given assuming that, preferably, no response is made to information in a communication format or data format to which their own function and performance do not conform.

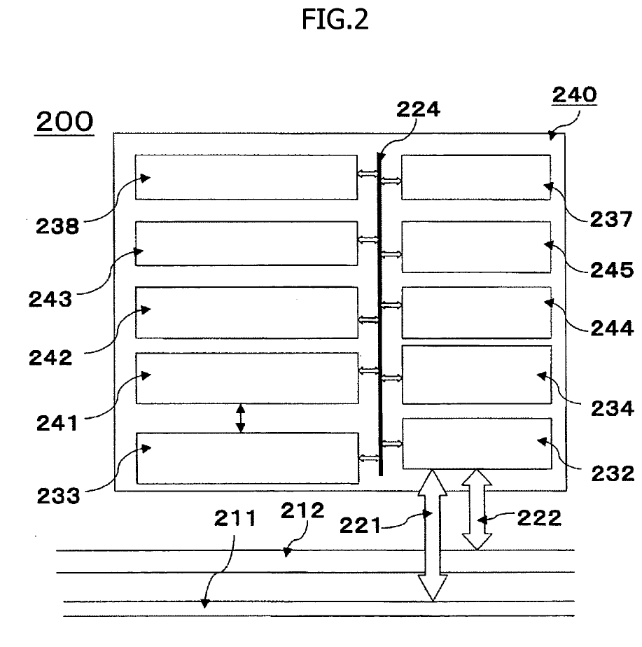

The associated apparatus 104 in a first embodiment can have an internal configuration as shown in FIG. 2. Some elements, such as user (customer or client) management and fee recording, may be implemented by another server. Preferably, they have their own IP addresses.

In FIG. 2, an associated apparatus 240, which is one example of the associated apparatus 140, is one type of computer-controlled device, which is controlled by a microcomputer 234 via an internal bus 224. The associated apparatus 240 may have a processor 237 for performing dedicated calculations for Fourier transforms, simulation, and so on. A measuring-instrument user identifiers, usage-fee payer identifiers, IP addresses, measuring-instrument identifiers (including data on functions, performances, and so on), application license conditions, and so on are recorded in client-managing/fee-recording means 245 and are updated and recorded at every use. A measurement data memory 244 is connected to the internal bus 224. Measurement data (transmission data, reception data, and hardware setting data) are stored, for each user, in the measurement data memory 244. An operation panel for performing manual input and instruction inputting means 238 for performing instruction input processing, for example, interpret an input instruction, transfer the input instruction to the bus 224, and turn on an indicator light in response to an instruction from the microcomputer 234. Further, in many cases, the measuring instrument 240 includes an I/O slot 243 for connection with another apparatus and/or an extended memory. Additionally, in many cases, the measuring instrument 240 includes an application memory 242 for storing application software for converting measurement data, to perform various types of analysis and to download application software into a measuring instrument through a communications line. Alternatively, the analysis result, measurement data, input instruction, and client data are stored in a display memory 241 and are displayed on a display device 233. Further, communication (port) controlling means 232 for external communication is provided and is connected to external communications networks 212 and 211 via communication connections 222 and 221. The communications networks 212 and 211 are examples of the communications network 120. Although the communication (port) means 232 may be realized by inserting a card into the I/O slot 243, the communication (port) means 232 is independently illustrated for the sake of clarity of the description herein. The configuration of the associated apparatus 240, data stored therein, and so on can be partly changed through the instruction inputting means, an external apparatus connected to the I/O slot, or the communications line.

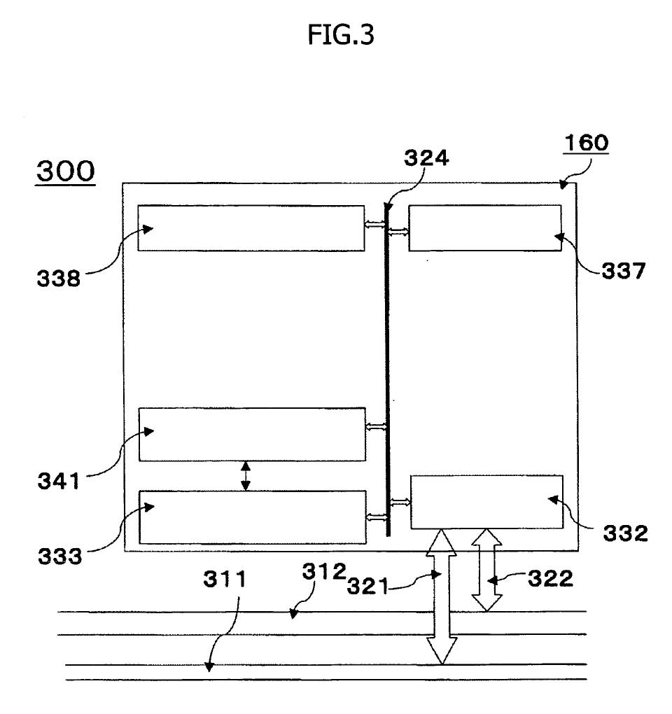

While the measuring instrument 16 may also be used as the measuring instrument in the first embodiment of the present invention, the configuration can be further simplified, like that of the measuring instrument 160. The measuring instrument 160 has a fewer pieces of hardware than the measuring instrument 16, thus offering an advantage in that the hardware-procuring cost and operating cost are reduced. As shown in FIG. 3, the measuring instrument 160 preferably includes instruction-input processing means 338 having an operation panel, signal transmission/reception standardizing means 337 for DUT-interface/data-conversion standardization, a display memory 341, a display device 333, and a communication controlling means 332.

An instruction for preparation, start, or suspension of measurement, or an instruction for internal setting or the like is manually input through the operation panel and is then decoded by the instruction-input means 338, and instruction digital data is sent to the communication controlling means 332. The communication controlling means 332 employs appropriate security and preferably encrypts the instruction digital data and transmits the resulting instruction digital data onto a communications network 312 via a communications-network connection device 322 so that the instruction digital data is read by the associated apparatus 140.

The associated apparatus 140 receives and decodes the instruction digital data and identifies measurement parameters of the measuring instrument 160. Examples of the measurement parameters include a user identifier, measuring-instrument type, measurement function/performance, display standard, and internal setting parameter. When the instruction indicates that additional internal setting is required in the measuring instrument 160, the associated apparatus 140 transmits internal setting data to the measuring instrument 160 to cause internal setting in the signal transmission/reception standardizing means 337 and so on.

Being triggered by reception of the internal setting data or in response to an additional instruction sent from the operation panel, the signal transmission/reception standardizing means 337 in the measuring instrument 160 transmits/receives a series of measurement signals to/from the DUT 150. The measuring instrument 160 converts the measurement value of a physical quantity corresponding to the DUT 150 into digital measurement data and transmits the digital measurement data to the associated apparatus 140 through the communications-network connection device 322 and the communications network 312.

In accordance with the digital measurement data and the measurement parameters, the associated apparatus 140 selects an appropriate application and an application processing device to execute the application and returns result data to the measuring instrument 160. When a necessary application and a necessary application processing device are located at another associated apparatus, the associated apparatus 140 can obtain result data converted by a predetermined application, through communication with that associated apparatus. Upon approval, the measuring instrument 160 can also make changes in that associated apparatus.

The measuring instrument 160 receives the result data, stores the result data in the display memory 341, and displays the result data on the display device 333.

In the above-described series of communications, when the associated apparatus 140 charges a usage fee for a pay service, a usage record statement and a fee for each user are sequentially recorded in the client-managing/fee-recording means 245. The fee amount, a prepayment balance, and so on can also be displayed on the display device 333 together with the above-mentioned result data.

When an instruction for measurement suspension is received from the measuring instrument 160 or when the charge is projected to exceed a specified fee or has already exceeded it during continuous measurement, result data is stored, the execution of the application is suspended, and charge information is displayed on the display device 333 at the measuring instrument. Additionally, it is preferable to allow the specified fee to be changed. Upon completion of the change, the application is restarted and the returning of the result data is started.

Further, in response to an instruction for desiring an application electronic mall for realizing a measurement function, the associated apparatus 140 may cooperate with an electronic mall server so as to allow the user of the measuring instrument to select an appropriate application. The electronic mall is operated via the display device 333 and the operation panel.

With a configuration in which a bidirectional bus having a communication port (for transmitting/receiving both power and data) is used, as in the Dallas 1-Wire system, the measuring instrument 160 can be powered by signals from an external communications network. Thus, the measuring instrument 160 requires no power supply or can include a long-life battery or dry cell, thus making it possible to eliminate wires for supplying power. With this configuration, the cooperation of the associated apparatus 140, the communications network 312, and so on is important.

Additionally, it is possible to improve efficiency by preparing a plurality of communications connection devices and a plurality of communications networks and selectively using them in response to an instruction or data.

Currently, mobile communications using i-mode or other types of mobile phone, PHS (Personal Handyphone System), and so on are in widespread use and are becoming increasingly sophisticated. In addition, for example, wireless LAN (WLAN: wireless local area networking) and WPAN (wireless personal area networking) utilizing the 2.4 GHz band can be universally used for wireless communications without a license. Wi-Fi (IEEE802.11b), which is being promoted for standardization, is expected to secure a transmission distance of up to about 100 m at a maximum data. transmission speed of 11 Mbps. Bluetooth version 1.1 is also expected to secure a transmission distance of up to about 10 m at a maximum data transmission speed of 1 Mbps.

Portable information terminals (PDAs: personal digital assistants) appear to be becoming increasingly popular, and this popularity is further driven with the realization of wireless roaming coming into sight. For example, the next generation WindowsCE, the release of which Microsoft Corporation has announced, is supposed to allow for seamless switching between three systems, namely, wireless LAN systems, the European mobile telephone standard GSM system, and packet communication systems using mobile phone networks. Many PDAs have existing interfaces, such as Ethernet, USB, IrDA, or AC'97 interfaces.

In addition, a basis exists for an improvement in data transmission speed. For example, in optical communication systems based on a WDM (wavelength division multiplexing) system, a transmission speed of 40 Gbps to, experimentally, several Tbps has been accomplished.

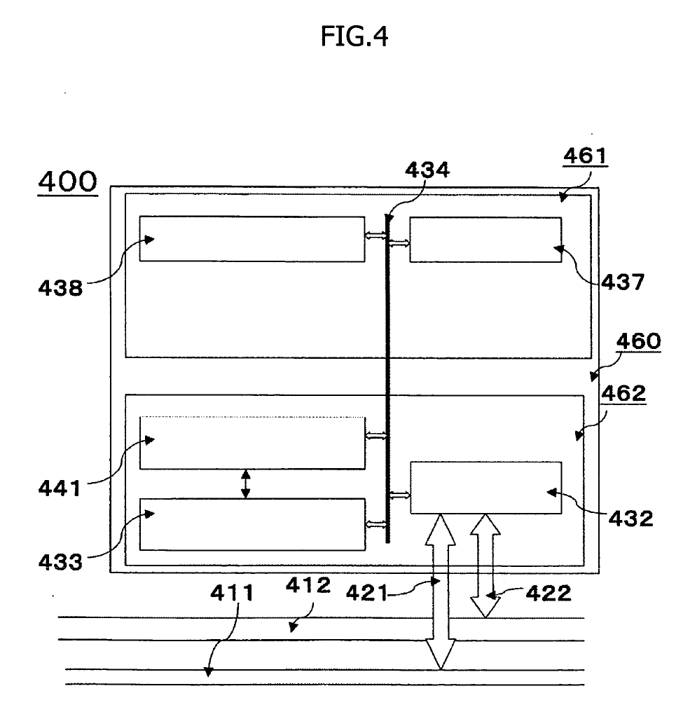

In view of the sophistication of commercially-available communication apparatuses, in a second embodiment of the present invention, as shown in FIG. 4, a measuring instrument 460 is separated into a communication/display section 462 and a measurement interface section 461. A commercially-available mobile apparatus is preferably used as-is for the communication/display section 462. A commercially-available mobile apparatus, however, may be slightly modified.

An associated apparatus (or a server) can act as an information provider, can realize a billing function in the network management/operation means 110, and can outsource the collection of a fee, i.e., an actual information-fee, to a communications carrier or the like.

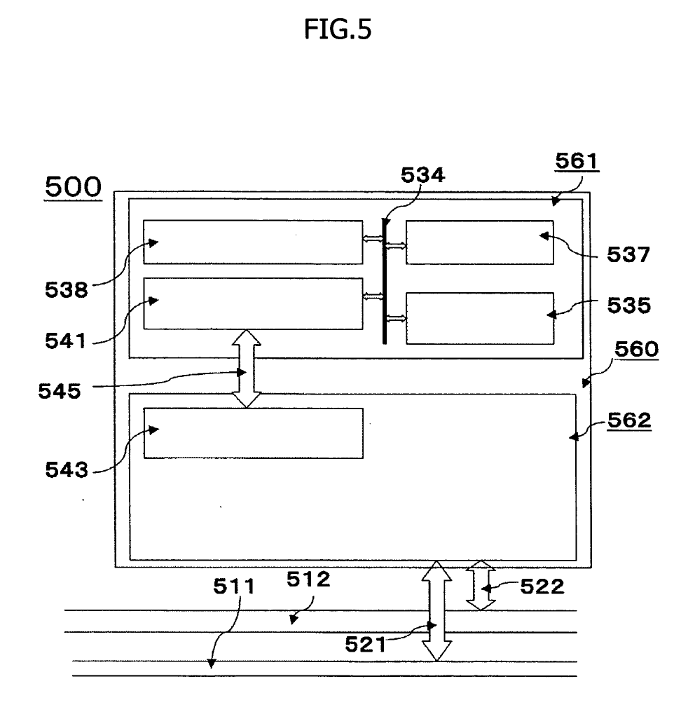

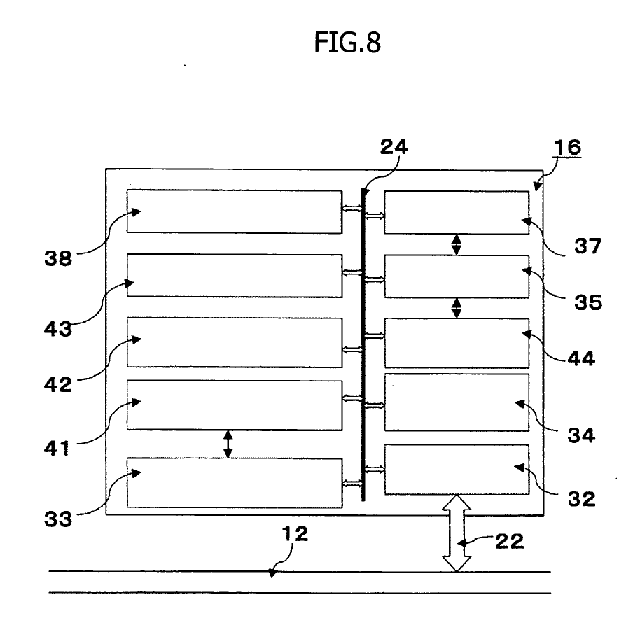

In a third embodiment of the present invention, as shown in FIG. 5, unlike the measuring instrument 16 shown in FIG. 8, in a measuring instrument 560 in a measurement system 500, a master device 562, such as a micro controller or personal computer, is connected to a measuring section 561 for performing measurement via an I/O connection 545. The master device 562 is connected to the associated apparatus 240 through line connection devices 521 and 522 and communications lines 511 and 512 (which are examples of the communications network 120), such as a LAN and the Internet. The measuring section 561 may be constituted by merely a signal sampler and an analog-to-digital converter, or may be implemented by, for example, a 1-Wire™ bus system available from Dallas/Maxim Inc. in the United States. An interface 541 is connected to a standard I/O slot 543 in the master device, so as to control a bus 534. A plurality of slave devices 535, 537, and 538 may be connected to devices under test (DUTs) or they may themselves be devices under test.

The master device 562 selects an application (software), permitted to be used, in a browser or an electronic mall to download the application from the associated apparatus 240 and executes the downloaded application. The associated apparatus 240 clocks the time from when the download is started until the application is closed and the execution is finished, and performs measured-rate or flat-rate billing in accordance with the license conditions. The associated apparatus 240 can transmit a notification indicating the estimated cumulative time and charge during execution to the master device 562 for display.

The arrangement may also be such that a discount for a usage fee can be adjusted in accordance with the cumulative usage fee and/or the cumulative usage time.

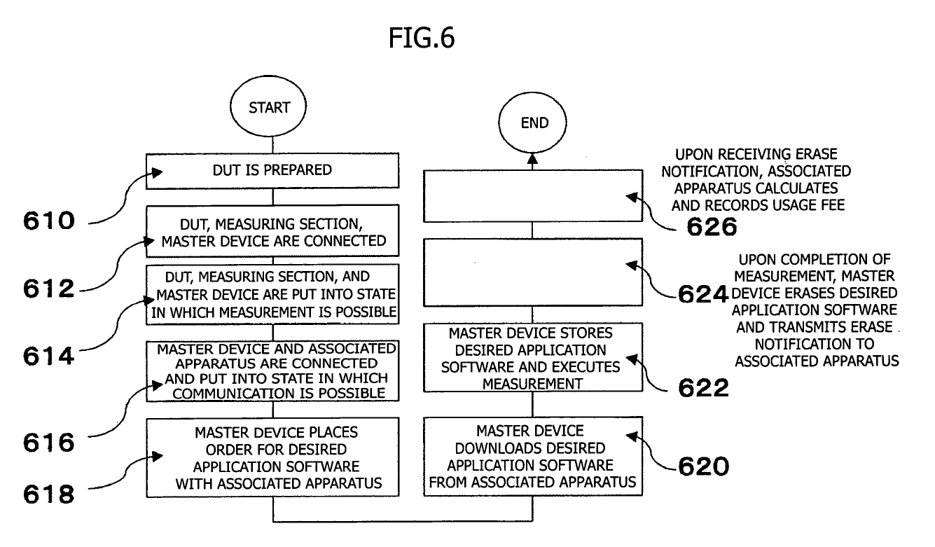

One example of a process for performing measurement in the present embodiment will now be described with reference to a flow diagram shown in FIG. 6. This example of the process includes steps 610 to 624. However, there is no need to perform steps 610 to 624 in the following order and a change is possible thereto as long as the apparatuses are not damaged and an agreement is not violated. For example, in some cases, step 610 can be moved to the end of step 620. Step 610: The DUT 150 is prepared. Step 612: The DUT 150 and the measuring section 561 are connected to the master device 562. Step 614: The DUT 150, the measuring section 561, and the master device 562 are put into a state in which measurement is can be started. Step 616: The master device 562 and the associated apparatus 240 are connected and are put into a state in which communication is possible.

Step 618: According to a certain usage condition, the master device 562 places an order for downloading desired application software with the associated apparatus 240, the desired application software being selected in accordance with an instruction from the operation panel. Step 620: When determining that the order is valid by referring to the client-managing/fee-recording means 245, the associated apparatus 240 downloads and leases the application software to the master device 562. As the same time, the associated apparatus 240 initializes a clock regarding the master device 562 and the application software. Alternatively, the associated apparatus 240 reads the start time from a shared clock and records the time. When the start of usage is recorded based on time, it is preferable to use either the download start time or the download end time. When the start of usage is recorded in response to event occurrence, it is also preferable to use either the start of download or the end of download.

Step 622: the master device 562 stores and executes the application software. In response to an instruction from the master device 562, the associated apparatus 240 transmits information on usage time, usage fee, and so on to the master device 562 as appropriate, and the master device 562 displays the information as needed.

Step 624: The master device 562 erases the application software in response to the ending of measurement that uses the application software and simultaneously transmits an erase notification to the associated apparatus 240.

Step 626: Upon receiving the erase notification, the associated apparatus 240 reads an elapsed time from the clock, calculates a usage fee corresponding to the elapsed time, and records the calculated usage fee in the client-managing/fee-recording means 245. If necessary, the associated apparatus 240 transmits a notification indicating the elapsed time and/or the usage fee to the master device 562 for confirmation. The master device 562 can display the received elapsed time and/or the usage fee.

In a system in which a fee is charged according to the number of uses of application software, in step 620, the associated apparatus 240 can cause a counter module to count the number of uses in response to the downloading. Further, in step 624, the associated apparatus 240 can collect or read the counter module to calculate the usage fee.

Preferably, the master device 562 can measure the number of uses and the usage time of the application software and also can transmit a notification thereof to the associated apparatus 240.

While the embodiments of the present invention have been described above, various changes and modifications are possible thereto within the scope of the present invention and the embodiments are not intended to limit the scope of the present invention.

1. A measurement system comprising:
instruction inputting means having an operation panel for inputting an instruction regarding a configuration of the measurement system;
a test interface;
signal transmission/reception standardizing means for transmitting/receiving a signal to/from a device under test via the test interface;
transmitting means for transmitting information to a communications network, the information being based on at least part of a measuring function and an output from the signal transmission/reception standardizing means;
application executing means for, upon connection with the communications network to receive the information, either performing conversion specified by the information on the information to obtain measurement information and transmitting the measurement information to the communications network or transmitting application software for performing the conversion;
receiving means for receiving the measurement information from the communications network;
displaying means for performing display in accordance with the application software or the measurement information received by the receiving means; and
billing means for updating a given billing record in response to the conversion or the transmission of the application software.

2. The measurement system according to claim 1, wherein the application executing means has billing means and transmits at least part of the billing record based on the measurement information together with the measurement information.

3. The measurement system according to claim 1 or 2, wherein the application executing means has an electronic mall function that allows a large number of sets of the conversions to be displayed and that allows a desired one of the conversions or the application software to be selected and specified through setting of the operation panel.

4. The measurement system according to one of claims 1 to 3, wherein the operation panel, the transmitting means, and the receiving means are included in a portable information terminal or a mobile phone.

5. The measurement system according to claim 4, wherein the portable information terminal or the mobile phone includes the displaying means.

6. The measurement system according to one of claims 1 to 3, wherein the operation panel, the transmitting means, the receiving means, and the displaying means are included in a personal computer.

7. A measurement system in which a measuring instrument, to which a device under test is connected, and an associated apparatus, which provides application software for converting measurement data, are connected through a communications network, wherein the associated apparatus records a usage fee for the application software.

8. The measurement system according to claim 7, wherein the measuring instrument downloads the application software from the associated apparatus and executes the application software to record an amount of use for calculation of the usage fee, and the associated apparatus receives the amount of use and calculates the usage fee.

9. The measurement system according to claim 7, wherein the measuring instrument downloads the application software from the associated apparatus, receives a limit value for an amount of use, and executes the application software within the limit value.

10. The measurement system according to claim 9, wherein the measuring instrument further records the amount of use of the application software and transmits a difference between the amount of use and the limit value to the associated apparatus.

11. A method for performing measurement in a measurement system in which a measuring instrument is connected to an associated apparatus through a communications network, the measuring instrument including a measuring section to which a device under test is connected and a master device for controlling the measuring section to thereby perform measurement of the device under test, the method comprising the steps of:
preparing a device under test;
connecting the device under test and a measuring section to a master device;
putting the device under test, the measuring section, and the master device into a state in which measurement can be started;
connecting the master device and the associated apparatus to put the master device and the associated apparatus into a state in which communication can be performed;
causing the master device to place an order for downloading desired application software to the associated apparatus according to a certain usage condition, the desired application software being selected in accordance with an instruction from an operation panel of the master device;
causing the associated apparatus to approve a validity of the order, download the desired application software onto the master device, and store the start of use;
causing the master device to store the desired application software and execute measurement of the device under test;
causing the master device to erase the desired application software in response to ending of the measurement that uses the desired application software and simultaneously transmit an erase notification to the associated apparatus; and
causing the associated apparatus to calculate a usage fee upon receipt of the erase notification and record the usage fee.

12. The measurement method according to claim 11, wherein in the step of storing the start of use, the start time of the download is stored, and in the step of calculating and recording the usage fee, based on an elapsed time from the start time until the erase notification is received, a usage fee corresponding to the elapsed time is calculated and recorded.

13. The measurement method according to claim 11, wherein in the step of storing the start of use, the associated apparatus transfers a counter module for counting the number of uses of the desired application software to the master device together with the download; in the step of executing the measurement, the counter module counts the number of uses; in the step of transmitting the erase notification, the counter module is collected; and in the step of calculating and recording the usage fee, a usage fee is calculated by reading the number of uses from the counter module.

14. The measurement method according to claim 12 or 13, wherein, in the step of executing the measurement, the associated apparatus transmits the elapsed time or the usage fee to the master device.

15. The measurement method according to claim 14, wherein the master device displays the transmitted elapsed time or the usage fee.
